(19) United States
(12) Patent Application Publication
(10) Pub. No.: US 2013/0173935 A1
(43) Pub. Date: Jul. 4, 2013

(54) POWER CONTROL METHOD AND APPARATUS FOR ARRAY PROCESSOR

(71) Applicants: Ho Yang, Hwaseong-si (KR); Kyeong Yeon Kim, Hwaseong-si (KR); Young Hwan Park, Yongin-si (KR); Ki Taek Bae, Hwaseong-si (KR)

(72) Inventors: Ho Yang, Hwaseong-si (KR); Kyeong Yeon Kim, Hwaseong-si (KR); Young Hwan Park, Yongin-si (KR); Ki Taek Bae, Hwaseong-si (KR)

(21) Appl. No.: 13/606,384

(22) Filed: Sep. 7, 2012

(30) Foreign Application Priority Data
Jan. 4, 2012 (KR) 10-2012-0001168

(51) Int. Cl. G06F 1/26

(52) U.S. Cl. 713/300

(57) ABSTRACT

Provided is an apparatus and method for controlling power to a reconfigurable array processor. The method may determine one or more function units (FUs) as activation function units (FUs) and deactivation FUs among a plurality of FUs included in the reconfigurable array processor. The processor may interrupt power supplied to the deactivation FUs.

### CROSS-REFERENCE TO RELATED APPLICATION(S)

This application claims the benefit under 35 USC §119(a) of Korean Patent Application No. 10-2012-0001168, filed on Jan. 4, 2012, in the Korean Intellectual Property Office, the entire disclosure of which is incorporated herein by reference for all purposes.

### BACKGROUND

1. Field

The following description relates to a method and an apparatus for reducing power consumption by only using some resources in an array processor while efficiently interrupting power with respect to a remaining portion of the resources.

2. Description of the Related Art

In general, a reconfigurable array processor includes a plurality of function units (FUs). Typically, a scheduler of the reconfigurable array processor uses a hardware resource by evenly allocating an amount of calculation to most or all of the FUs included in the reconfigurable array. Therefore, almost all the FUs are typically used to process instructions. A reconfigurable array includes a reconfigurable architecture that dynamically connects operators in the plurality of FUs to parallel-process a series of particular functions. The FUs includes operators for performing computation with respect to data stored in a register file.

However, when all of the FUs are used, power needs to be supplied to all the FUs, thereby increasing power consumption.

### SUMMARY

In an aspect, there is provided a power control method of a processor including a plurality of function units (FU), the method including determining at least one activation FU and at least one deactivation FU, from among the plurality of FUs, calculating a performance of the plurality of FUs based on a compiling result of the at least one activation FU, and controlling the supply of power with respect to the plurality of FUs based on the calculated performance of the plurality of FUs.

The determining may comprise calculating a usage rate of the plurality of FUs by performing compiling with respect to all of the plurality of FUs included in the reconfigurable array processor, and sorting the plurality of FUs into the at least one activation FU and the at least one deactivation FU based on the usage rate of the plurality of FUs and a reference usage rate.

The determining may comprise determining the at least one activation FU and the at least one deactivation FU from among the plurality of FUs based on complex instructions allocated to the plurality of FUs.

The determining may comprise determining, as a deactivation FU, an FU allocated with complex instructions and which is not included in a kernel to be executed in the reconfigurable array processor.

The determining may comprise determining, as an activation FU, an FU allocated with a complex instruction and which is included in a kernel to be executed in the reconfigurable array processor.

The controlling may comprise determining whether to change at least one deactivation FU into an activation FU, based on the performance of the plurality of FUs and a reference performance.

The calculating may comprise recalculating the performance of the plurality of FUs by performing compiling with respect to the at least one activation FU determined from among the plurality of FUs and at least one activation FU changed from a deactivation FU.

The controlling may comprise determining a deactivation FU to be changed to an activation FU, based on complexity of an instruction allocated to the deactivation FU.

The controlling may comprise controlling the supply of power to a deactivation FU by performing power gating or clock gating with respect to the deactivation FU.

In an aspect, there is provided a power control apparatus of a processor including a plurality of function units (FU), the apparatus including a function unit (FU) determination unit to determine at least one activation FU and at least one deactivation FU, from among the plurality of FUs, a performance calculation unit to calculate a performance of the plurality of to FUs based on a compiling result of the at least one activation FU, and a power control unit to control power supply with respect to the plurality of FUs based on the calculated performance of the plurality of FUs.

The FU determination unit may calculate a usage rate of the plurality of FUs by performing compiling with respect to all of the plurality of FUs included in the reconfigurable array processor, and sort the plurality of FUs into the at least one activation FU and the at least one deactivation FU based on the usage rate of the plurality of FUs and a reference usage rate.

The FU determination unit may determine the at least one activation FU and the at least one deactivation FU based on complex instructions allocated to the plurality of FUs.

The FU determination unit may determine, as a deactivation FU, an FU allocated with a complex instruction and which is not included in a kernel to be executed in the reconfigurable array processor.

The FU determination unit may determine, as an activation FU, an FU allocated with a complex instruction and which is included in a kernel to be executed in the reconfigurable array processor.

The power control unit may determine whether to change at least one deactivation FU to an activation FU based on the performance of the plurality of FUs and a reference performance.

The performance calculation unit may recalculate the performance of the plurality of FUs by performing compiling with respect to the at least one activation FU determined out of the plurality of FUs the at least one activation FU that is changed from a deactivation FU.

The power control unit may determine a deactivation FU to be changed to an activation FU, based on complexity of an instruction allocated to the deactivation FU.

The power control unit may control the power supply to a deactivation FU by performing power gating or clock gating with respect to the deactivation FU.

In an aspect, there is provided a non-transitory computer readable recording medium storing a program to cause a computer to implement the method.

In an aspect, there is provided a processor including a plurality of functional units configured to process instructions, and a power control unit configured to supply power to one or more of the plurality of functional units and to deactivate power to one or more of the remaining plurality of functional units, during a processing cycle, based on the processing performance of the plurality of functional units.

The power control unit may determine to deactivate power to one or more of the remaining plurality of functional units based on complex instructions allocated to the plurality of functional units during the processing cycle.

Other features and aspects may be apparent from the following detailed description, the drawings, and the claims.

### BRIEF DESCRIPTION OF THE DRAWINGS

FIG. 1 is a diagram illustrating an example of a reconfigurable array processor including a plurality of function units (FU).

FIG. 2 is a diagram illustrating an example of a power control method using a reconfigurable array processor.

FIG. 3 is a diagram illustrating an example of a high usage rate of an array processor including 16 FUs.

FIG. 4 is a diagram illustrating an example of a low usage rate of an array processor including 16 FUs.

FIG. 5 is a diagram illustrating an example of an operation of determining a deactivation FU and an activation FU.

FIG. 6 is a diagram illustrating an example of an operation of controlling power supply with respect to FUs included in a reconfigurable array processor.

FIG. 7 is a diagram illustrating an example of a power control apparatus in a reconfigurable array processor.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

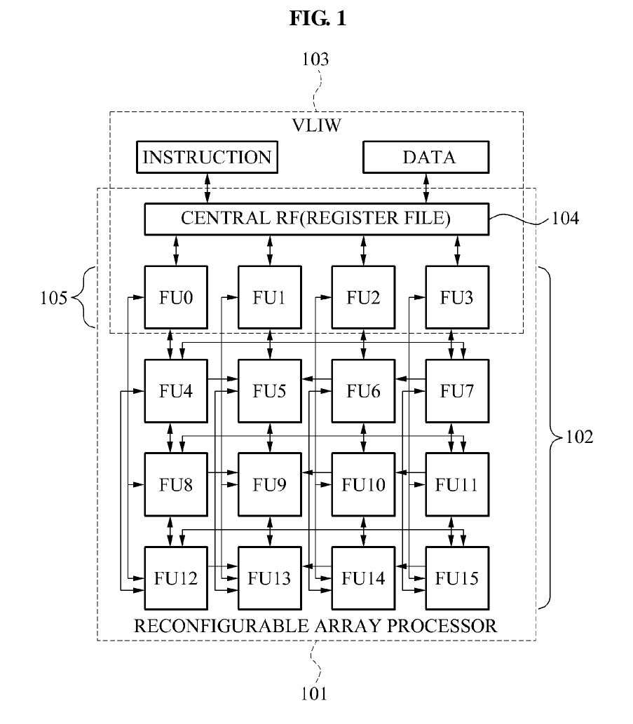

FIG. 1 illustrates an example of a reconfigurable array processor 101 including a plurality of function units (FU) 102. An example of the reconfigurable array processor 101 is a coarse-grained array, and the like.

Referring to FIG. 1, the reconfigurable array processor 101 includes the plurality of FUs 102 and a central register file 104. The plurality of FUs 102 may include a plurality of operators and perform computation. The central register file 104 may store data used for processing of the plurality of FUs 102 and processing results of the plurality of FUs 102.

A very long instruction word (VLIW) 103 refers to a host processor which controls operation of the reconfigurable array processor 101 includes FUs for executing a control code of a kernel. In the example of FIG. 1, the FU for performing the control code is FUs 105 (including FU0 through FU3) selected from the plurality of FUs 102 included in the reconfigurable array processor 101.

The central register file 104 may be shared by the VLIW 103, that is, the host processor, and the reconfigurable array processor 101 so that the two processors 103 and 101 may exchange data.

Instructions for executing the kernel may be allocated to the plurality of FUs 102. For execution of the instructions, power may be supplied to all corresponding FUs. As described herein, the kernel refers to a program that is executed in the reconfigurable array processor. For example, the kernel may be a program including a loop as shown in Table 1 below.

TABLE 1

For(i=0; i<100; i++)
{

j=i+1
k=k*j

}

According to various aspects, the power control apparatus may reduce power consumption by performing power gating or clock gating with respect to some of the plurality of FUs, to which the instructions are not applied. For example, the power gating denotes an interruption of power supplied to the plurality of FUs and the clock gating denotes an interruption of a clock supplied to the plurality of FUs.

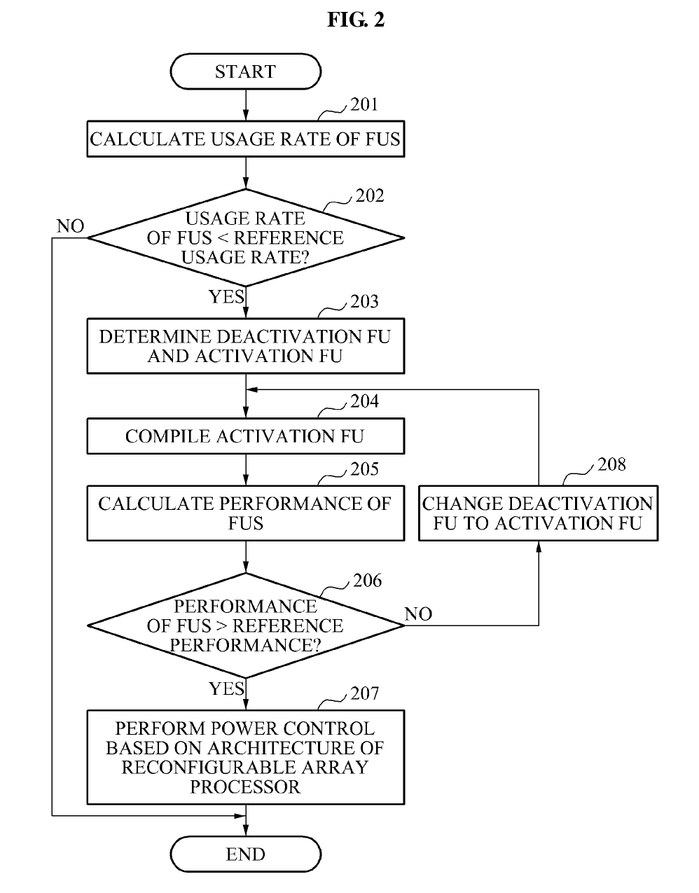

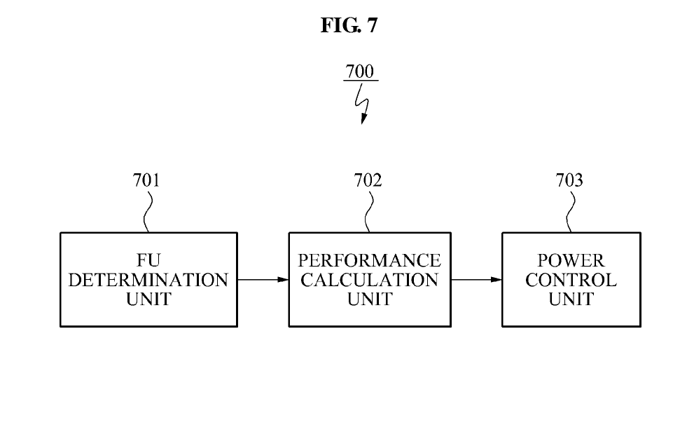

FIG. 2 illustrates an example of a power control method using a reconfigurable array processor. For example, the power control method may be performed by a power control apparatus shown in FIG. 7.

Referring to FIG. 2, to determine whether to apply the power control method, the power control apparatus may perform compiling in a state in which all of the FUs included in the reconfigurable array processor are activated. For example, if the reconfigurable array processor includes 16 FUs, the power control apparatus may perform compiling using all of the 16 FUs.

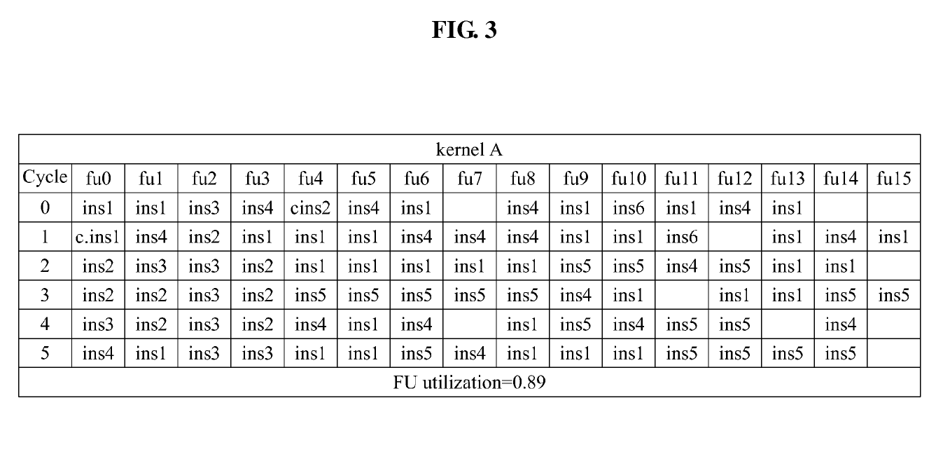

In operation 201, the power control apparatus calculates a usage rate of the plurality of FUs based on a result of compiling performed with all of the FUs activated. For example, the power control apparatus may calculate the usage rate based on a number of instructions used in the plurality of FUs, a number of cycles, a total number of the plurality of FUs, and the like. For example, there may be 16 FUs included in the reconfigurable array processor, the number of cycles may be 6, and the number of instructions allocated to the 16 FUs may be 8, as shown in FIG. 3. In this example, the power control apparatus may calculate the usage rate to be 0.89. Accordingly, the usage rate of the plurality of FUs may also be expressed as 89%. As another example, the power control apparatus may use instruction level parallel (ILP) to calculate the usage rate.

The power control apparatus may determine whether to perform power control with respect to the kernel based on the usage rate of the plurality of FUs, and may sort the plurality of FUs into one or more activation FUs and one or more deactivation FUs. A deactivation FU refers to an FU that is excluded from object FUs during compiling. Power may not be supplied to a deactivation FU during a processing cycle. An activation FU refers to an FU that is supplied power during a processing cycle. Examples for determining the activation FUs and the deactivation FUs are described herein.

For example, the power control apparatus may determine to perform power control with respect to a kernel having a relatively low usage rate. As another example, the power control apparatus may determine not to perform power control with respect to a kernel having a relatively high ILP because power control is relatively ineffective with respect to the kernel having the relatively high ILP.

In operation 202, the power control apparatus determines whether to perform power control based on the usage rate of the plurality of FUs and a reference usage rate of an FU. For example, if the reference usage rate is preset to a %, the power control apparatus may determine to perform power control with respect to the kernel if the usage rate of the plurality of FUs is less than a %. The power control apparatus may perform power control by interrupting power or a clock that is supplied to the deactivation FU.

In operation 203, the power control apparatus determines the deactivation FUs and the activation FUs from among the plurality of FUs included in the reconfigurable array processor. For example, the deactivation FUs and the activation FUs may be determined based on complex instructions that are allocated to the respective FUs included in the reconfigurable array processor. Here, the complex instructions refer to instructions used for the kernel, and which have a complex structure including at least two addition, multiplication, or shift signs in a brace ({ }) as shown in the example of the loop of Table 1. For example, the complex instructions may be instructions for performing calculations such as division, square-root, complex multiplication, and the like.

The power control apparatus may determine, as an activation FU, an FU that is allocated with the complex instructions that are included in the kernel to be executed by the reconfigurable array processor. In this example, the activation FU includes all instructions used in the kernel and has a usage rate of K % or higher with respect to the all FUs.

In addition, the power control apparatus may determine, as a deactivation FU, an FU that is allocated with complex instructions but which is not included in the kernel to be executed in the reconfigurable array processor. Here, the power control apparatus may determine the deactivation FU based on complexity of the instructions allocated to the plurality of FUs.

In operation 204, the power control apparatus performs compiling with respect to the activation FUs from among the plurality of FUs included in the reconfigurable array processor. For example, referring to FIG. 1, if 11 FUs are determined to be activation FUs and 5 FUs are determined to be deactivation FUs, compiling may be performed only with respect to the 11 activation FUs.

In operation 205, the power control apparatus calculates performance of the plurality of FUs based on a result of compiling the activation FUs. For example, a cycle for operating an objective kernel in the reconfigurable array processor may be calculated. A cycle penalty, which is a difference between the calculated cycle and a cycle necessary to activate all the plurality of FUs, may be used as the performance of the activation FU.

In operation 206, the power control apparatus determines whether to change at least one of the deactivation FUs to an activation FU, based on the performance of the activation FUs and a reference performance.

For example, if the performance of the activation FUs is greater than or equal to the reference performance, the power control apparatus may store an architecture of the reconfigurable array processor and perform power control based on the architecture, in operation 207. As an example, the reference performance may be preset to b % lower than the performance of in which all of the plurality of FUs are compiled. In other words, the reference performance may be preset to a threshold value which may reduce performance deterioration to an allowable range or improve the performance even though compiling is only performed with respect to the activation FUs.

As another example, if the performance of the plurality of FUs is less than the reference performance, the power control apparatus may determine to change at least one of the deactivation FUs to an activation FU, in operation 208. Accordingly, the power control apparatus may perform rescheduling with respect to the plurality of FUs included in the reconfigurable array processor, based on the performance of the plurality of FUs and the reference performance of an FU.

For example, the power control apparatus may change (i.e. reschedule) at least one of the deactivation FUs to an activation FU based on a complexity of instructions allocated to the deactivation FUs. As an example, assume there are three FUs from a deactivation FU 1 through to a deactivation FU 3. If a complexity of the deactivation FU 1 is the lowest and complexity of a deactivation FU 2 is the secondly lowest, the power control apparatus may change the deactivation FU 1, the deactivation FU 2, and the deactivation FU 3, to activation FUs in the aforementioned order. Here, if the intent is to change only one deactivation FU to an activation FU, the power control apparatus may change only the deactivation FU 1 to an activation FU. As another example, if the intent is to change two deactivation FUs to activation FUs, the power control apparatus may change the deactivation FUs 1 and 2 to activation FUs. In this example, the power control apparatus may change deactivation FUs to activation FUs in order of lowest complexity to highest complexity.

In addition, the power control apparatus may repeat operations 204 to 206 after changing the at least one deactivation FU to an activation FU. For example, operations 204 to 206 may be repeated until the performance of the activations FUs is above the reference performance.

In an example in which 16 FUs of the array include 5 deactivation FUs and 11 activation FUs, in response to one deactivation FU being changed to an activation FU, the power control apparatus may again perform compiling with respect to the 12 activation FUs including the newly changed activation FU. Additionally, the power control apparatus may recalculate performance of the plurality of FUs based on a result of the compiling. In response, the power control apparatus may determine whether to change another deactivation FU to an activation FU by comparing the recalculated performance with the reference performance. In this example, the power control apparatus may repeat compiling and calculation of the performance of the plurality of FUs until the recalculated performance becomes or exceeds the reference performance.

If the recalculated performance becomes or exceeds the reference performance, the power control apparatus may store an architecture of the reconfigurable array processor, which corresponds to a result of compiling the activation FU. For example, the architecture of the reconfigurable array processor may include a hardware architecture indicating the deactivation FUs and the activation FUs from among the plurality of FUs included in the reconfigurable array processor. The architecture of the reconfigurable array processor may include a hardware architecture that excludes the deactivation FUs from objects of scheduling among the plurality of FUs included in the reconfigurable array processor.

According to various aspects, the power control apparatus may perform power gating or clock gating with respect to the deactivation FUs, based on the architecture of the reconfigurable array processor. For example, the power control apparatus may perform power control so that a supply of power or the clock to the deactivation FU is interrupted. Conversely, the power control apparatus may perform power control so that supply of the power or the clock to the activation FUs is maintained.

According to various aspects, the power control apparatus may supply power to only the activation FUs, rather than to all the plurality of FUs, with respect to a kernel to be executed in the reconfigurable array processor. Accordingly, power which would have been supplied to the deactivation FUs may be saved. Furthermore, because the performance of the plurality of FUs is checked during the power control, the power control apparatus may reduce power consumption while maintaining the performance of a reference performance.

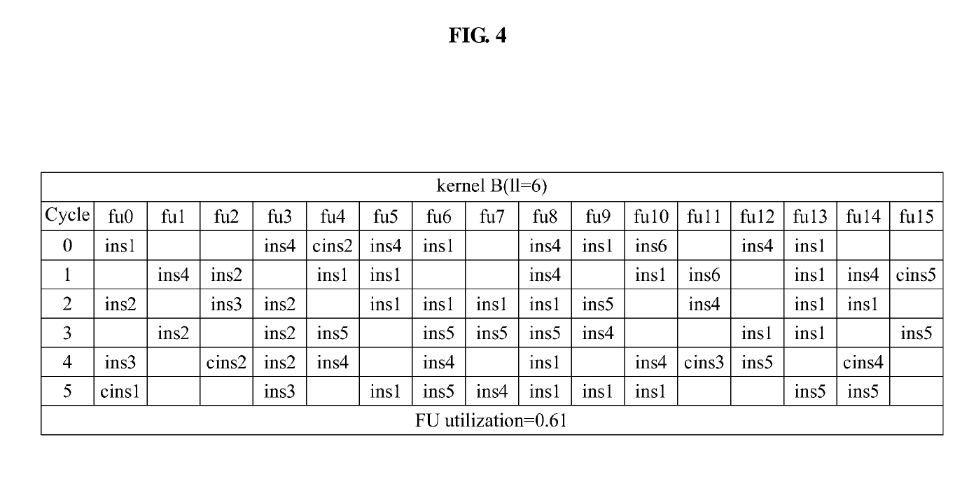

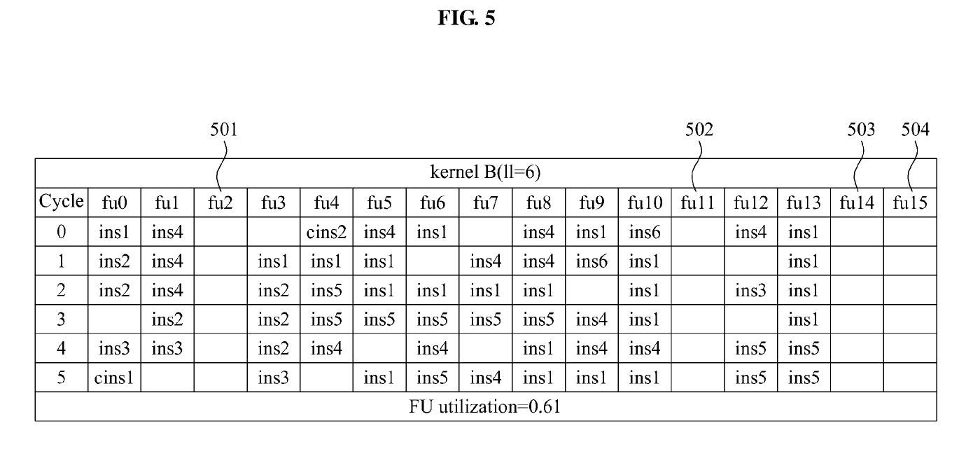

FIG. 4 illustrates an example of a low usage rate of an array processor including 16 FUs. FIG. 5 illustrates an example of an operation of determining a deactivation FU and an activation FU.

Referring to FIG. 4, the power control apparatus may calculate the usage rate of the plurality of FUs based on a result of compiling that is performed with all of the plurality of FUs being activated.

In the example of FIG. 4, the reconfigurable array processor includes 16 FUs, a number of repeated cycles is 6, and a number of instructions allocated to the 16 FUs is 59. Accordingly, the power control apparatus may calculate the usage rate of the plurality of FUs to be 0.61 (i.e. 59/(6*16)). In this case, the usage rate of the plurality of FUs may be expressed as approximately 60%.

If a reference usage rate of the plurality of FUs is preset to 70%, the power control apparatus may compare the usage rate 60% of the plurality of FUs with the reference usage rate 70%. In this example, because the usage rate 60% is less than the reference usage rate 70%, the power control apparatus may determine to perform power control with respect to a kernel to be executed in the reconfigurable array processor.

The power control apparatus may determine activation FUs and deactivation FUs from among the plurality of FUs included in the reconfigurable array processor. As shown in FIG. 4, the power control apparatus may determine the activation FUs and the deactivation FUs from among FU 0 to FU 15. For example, the power control apparatus may determine an FU allocated with a complex instruction included in the kernel as the activation FU, regardless. Also, the power control apparatus may determine an FU allocated with a complex instruction but which is not included in the kernel as a deactivation FU.

Referring to FIG. 5, because a complex instruction cins 1 included in the kernel is allocated to the FU 0, the power control apparatus may determine the FU 0 to be the activation FU, unconditionally. In this example, complex instructions cins 2, cins 3, cins 4, and cins 5, which are not included in the kernel, are allocated to an FU 2 501, an FU 11 502, an FU 14 503, and an FU 15 504, respectively. Accordingly, the power control apparatus may determine the FU 2, the FU 11, the FU 14, and the FU 15 as the deactivation FUs. In addition, the power control apparatus may determine the remaining FUs, that is, an FU 1, FUs 3 to 10, and FUs 12 and 13 as the activation FUs.

The power control apparatus may perform compiling for the activation FUs, that is, the FUs 0 to 1, the FUs 3 to 10, and the FUs 12 and 13. Also, the power control apparatus may calculate performance of the plurality of FUs based on a result of compiling the activation FUs.

If the performance of the plurality of activation FUs is greater than or equal to a reference performance, the power control apparatus may store an architecture of the reconfigurable array processor, which corresponds to the result of compiling the activation FUs, and perform power gating or clock gating with respect to the deactivation FUs. As another example, if the performance of the plurality of FUs is less than the reference performance, the power control apparatus may reconfigure one or more of the deactivation FUs included in the reconfigurable array processor into activation FUs in an effort to increase the performance of the plurality of FUs.

For example, the power control apparatus may change a deactivation FU to an activation FU in order of lowest to highest complexity of the instructions allocated to the deactivation FUs. For example, referring to FIG. 5, the power control apparatus may change at least one of the FU 2 501, the FU 11 502, the FU 14 503, and the FU 15 504 to activation FUs. For example, if the FU 2 501 has the lowest complexity, the power control apparatus may change the FU 2 501 to an activation FU and perform compiling again with respect to the FUs 0 to 10, and the FUs 12 and 13. Subsequently, the power control apparatus may recalculate the performance of the plurality of FUs based on a result of the compiling performed again. Additionally, the power control apparatus may perform power control by comparing the recalculated performance with the reference performance.

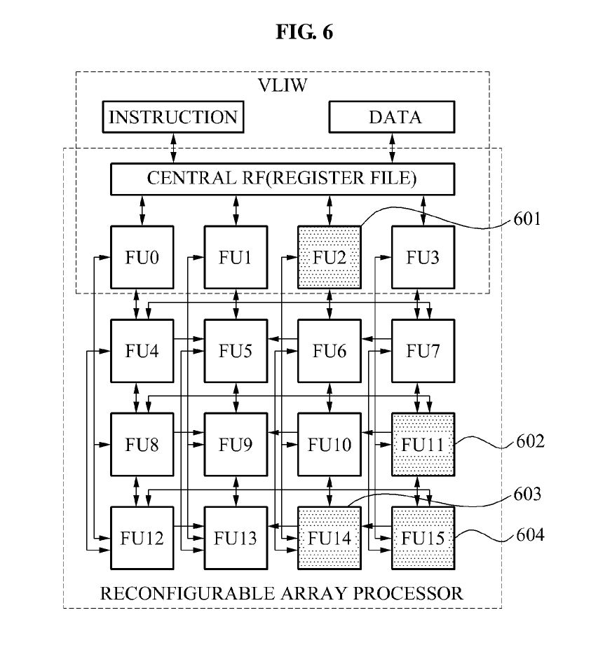

FIG. 6 illustrates an example of a power control operation performed with respect to a plurality of FUs included in a reconfigurable array processor.

Referring to FIG. 6, the power control apparatus may reduce power consumption by performing power gating or clock gating with respect to deactivation FUs 601, 602, 603, and 604 among the plurality of FUs included in the reconfigurable array processor.

In response to performing power gating, the power control apparatus may confirm that the FU 2 601, the FU 11 602, the FU 14 603, and the FU 15 604 are the deactivation FUs, based on architecture of the reconfigurable array processor. Accordingly, the power control apparatus may interrupt power supply to the FU 2 601, the FU 11 602, the FU 14 603, and the FU 15 604, thereby reducing unnecessary power consumption caused by execution of a to kernel in the reconfigurable array processor.

As another example, in response to performing clock gating, the power control apparatus may interrupt clock supply to the FU 2 601, the FU 11 602, the FU 14 603, and the FU 15 604, thereby reducing unnecessary power consumption.

FIG. 7 illustrates an example of a power control apparatus 700 using a reconfigurable array processor.

Referring to FIG. 7, the power control apparatus 700 includes an FU determination unit 701, a performance calculation unit 702, and a power control unit 703.

The FU determination unit 701 may calculate a usage rate of a plurality of FUs included in the reconfigurable array processor, in a state in which all of the plurality of FUs included in the reconfigurable array processor are activated.

Based on the calculated usage rate of the plurality of FUs and a predetermined reference usage rate of an FU, the FU determination unit 701 may determine one or more activation FUs and deactivation FUs from among the plurality of FUs. Here, the FU determination unit 701 may determine the activation FUs and the deactivation FUs based on complex instructions allocated to the plurality of FUs.

For example, if the usage rate of the plurality of FUs is less than the reference usage rate, the FU determination unit 701 may determine to perform power control with respect to a kernel to be executed in the reconfigurable array processor. Therefore, the FU determination unit 701 may determine an FU allocated with a complex instruction included in the kernel among the plurality of FUs, as an activation FU. As another example, the FU determination unit 701 may determine an FU allocated with a complex instruction that is not included in the kernel among the plurality of FUs, as a deactivation FU. Next, the FU determination unit 701 may determine the remaining FUs excluding deactivation FUs among the plurality of FUs, as the activation FUs. Here, the deactivation FUs may be excluded from object FUs of the compiling.

The performance calculation unit 702 may calculate a performance of the plurality of FUs based on a result of compiling of the activation FUs. For example, the performance calculation unit 702 may perform compiling only with respect to the activation FUs, excluding the deactivation FUs. In addition, the performance calculation unit 702 may calculate the performance of the plurality of FUs based on a result of compiling of the activation FUs. For example, the performance calculation unit 702 may calculate the performance based on a cycle penalty using a computation time elapsed for processing the kernel in the activation FU included in the reconfigurable array processor.

The power control unit 703 may control power supplied to the plurality of FUs based on the performance of the plurality of FUs and the reference performance. For example, if the performance of the plurality of FUs is greater than or equal to the reference performance, the power control unit 703 may perform power control based on a result of the compiling performed only with respect to the activation FUs. Here, the power control unit 703 may perform power gating or clock gating with respect to the deactivation FU.

If the performance of the plurality of FUs is less than the reference performance, the power control unit 703 may change at least one of the deactivation FUs to an activation FU. For example, the power control unit 703 may change at least one of the deactivation FUs to an activation FU based on complexity of an instruction allocated to the deactivation FUs.

Subsequently, the performance calculation unit 702 may recalculate the performance of the plurality of FUs, by performing compiling with respect to the activation FUs including the activation FU changed from the deactivation FU. In addition, the power control unit 703 may perform power control by comparing the recalculated performance with the reference performance. For example, the power control unit 703 may perform compiling by changing the deactivation FU to an activation FU until the recalculated performance matches or exceeds the reference performance.

According to various aspects, a plurality of FUs included in a reconfigurable array processor may be sorted into activation FUs and a deactivation FUs, and power supplied to the deactivation FUs may be controlled. As a result, power consumption may be reduced.

The examples herein are described with reference to a reconfigurable array processor, however, the examples are not limited thereto. For example, the descriptions herein may be applied towards any processor which includes an array of functional units.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A power control method of a processor including a plurality of function units (FU), the method comprising:
determining at least one activation FU and at least one deactivation FU, from among the plurality of FUs;
calculating a performance of the plurality of FUs based on a compiling result of the at least one activation FU; and
controlling the supply of power with respect to the plurality of FUs based on the calculated performance of the plurality of FUs.

2. The power control method of claim 1, wherein the determining comprises:
calculating a usage rate of the plurality of FUs by performing compiling with respect to all of the plurality of FUs included in the reconfigurable array processor; and
sorting the plurality of FUs into the at least one activation FU and the at least one deactivation FU based on the usage rate of the plurality of FUs and a reference usage rate.

3. The power control method of claim 1, wherein the determining comprises determining the at least one activation FU and the at least one deactivation FU from among the plurality of FUs based on complex instructions allocated to the plurality of FUs.

4. The power control method of claim 1, wherein the determining comprises determining, as a deactivation FU, an FU allocated with complex instructions and which is not included in a kernel to be executed in the reconfigurable array processor.

5. The power control method of claim 1, wherein the determining comprises determining, as an activation FU, an FU allocated with a complex instruction and which is included in a kernel to be executed in the reconfigurable array processor.

6. The power control method of claim 1, wherein the controlling comprises determining whether to change at least one deactivation FU into an activation FU, based on the performance of the plurality of FUs and a reference performance.

7. The power control method of claim 6, wherein the calculating comprises recalculating the performance of the plurality of FUs by performing compiling with respect to the at least one activation FU determined from among the plurality of FUs and at least one activation FU changed from a deactivation FU.

8. The power control method of claim 6, wherein the controlling comprises determining a deactivation FU to be changed to an activation FU, based on complexity of an instruction allocated to the deactivation FU.

9. The power control method of claim 1, wherein the controlling comprises controlling the supply of power to a deactivation FU by performing power gating or clock gating with respect to the deactivation FU.

10. A power control apparatus of a processor including a plurality of function units (FU), the apparatus comprising:
a function unit (FU) determination unit to determine at least one activation FU and at least one deactivation FU, from among the plurality of FUs;
a performance calculation unit to calculate a performance of the plurality of FUs based on a compiling result of the at least one activation FU; and
a power control unit to control power supply with respect to the plurality of FUs based on the calculated performance of the plurality of FUs.

11. The power control apparatus of claim 10, wherein the FU determination unit calculates a usage rate of the plurality of FUs by performing compiling with respect to all of the plurality of FUs included in the reconfigurable array processor, and sorts the plurality of FUs into the at least one activation FU and the at least one deactivation FU based on the usage rate of the plurality of FUs and a reference usage rate.

12. The power control apparatus of claim 10, wherein the FU determination unit determines the at least one activation FU and the at least one deactivation FU based on complex instructions allocated to the plurality of FUs.

13. The power control apparatus of claim 10, wherein the FU determination unit determines, as a deactivation FU, an FU allocated with a complex instruction and which is not included in a kernel to be executed in the reconfigurable array processor.

14. The power control apparatus of claim 10, wherein the FU determination unit determines, as an activation FU, an FU allocated with a complex instruction and which is included in a kernel to be executed in the reconfigurable array processor.

15. The power control apparatus of claim 10, wherein the power control unit determines whether to change at least one deactivation FU to an activation FU based on the performance of the plurality of FUs and a reference performance.

16. The power control apparatus of claim 15, wherein the performance calculation unit recalculates the performance of the plurality of FUs by performing compiling with respect to the at least one activation FU determined out of the plurality of FUs the at least one activation FU that is changed from a deactivation FU.

17. The power control apparatus of claim 15, wherein the power control unit determines a deactivation FU to be changed to an activation FU, based on complexity of an instruction allocated to the deactivation FU.

18. The power control apparatus of claim 10, wherein the power control unit controls the power supply to a deactivation FU by performing power gating or clock gating with respect to the deactivation FU.

19. A processor comprising:
a plurality of functional units configured to process instructions; and
a power control unit configured to supply power to one or more of the plurality of functional units and to deactivate power to one or more of the remaining plurality of functional units, during a processing cycle, based on the processing performance of the plurality of functional units.

20. The processor of claim 19, wherein the power control unit determines to deactivate power to one or more of the remaining plurality of functional units based on complex instructions allocated to the plurality of functional units during the processing cycle.
